(19) United States
(12) Patent Application Publication
(10) Pub. No.: US 2016/0277656 A1
(43) Pub. Date: Sep. 22, 2016

(54) DEVICE HAVING CAMERA FUNCTION AND METHOD OF IMAGE CAPTURE

(71) Applicant: KYOCERA CORPORATION, Kyoto (JP)

(72) Inventor: Hiroshi TSUNODA, Osaka (JP)

(21) Appl. No.: 15/166,046

(22) Filed: May 26, 2016

Related U.S. Application Data
(63) Continuation of application No. PCT/JP2014/081408, filed on Nov. 27, 2014.

(30) Foreign Application Priority Data
Nov. 27, 2013 (JP) 2013-244502

(51) Int. Cl. H04N 5/235; G06T 7/00; H04N 5/232; H04N 5/225; G06T 5/00

(52) U.S. Cl. CPC H04N 5/2353; H04N 5/2256; H04N 5/2351; G06T 5/002; H04N 5/23216; G06T 7/0081; H04N 5/23245; G06T 2207/20021; G06T 2207/10024

(57) ABSTRACT

A controller is configured to perform a first image capturing operation and a second image capturing operation based on a shutter operation, in the first image capturing operation a first image capturing unit capturing an image without light emission from a light emitter, in the second image capturing operation the first image capturing unit capturing an image with light emission from the light emitter, and divide an area of a first image captured by the first image capturing operation into an area of a subject and an area of a background based on a difference in state between corresponding portions of the first image and a second image captured by the second image capturing operation.

### CROSS-REFERENCE TO RELATED APPLICATION

The present application is a continuation based on PCT Application No. PCT/JP2014/081408 filed on Nov. 27, 2014, which claims the benefit of Japanese Application No. 2013-244502, filed on Nov. 27, 2013. PCT Application No. PCT/JP2014/081408 is entitled “Device Having Camera Function and Image Capturing Control Method”, and Japanese Application No. 2013-244502 is entitled “Device Having Camera Function, Image Capturing Control Method and Program.” The content of which are incorporated by reference herein in their entirety.

### FIELD

The present disclosure relates to a device having a camera function, such as a digital camera, a camera-equipped mobile phone, a camera-equipped PDA (Personal Digital Assistant), and a camera-equipped tablet PC. The present disclosure also relates to an image capturing control method applicable to such a device having a camera function.

### BACKGROUND

Many mobile terminal devices, such as mobile phones, are each equipped with a camera. A single-focus wide-angle camera tends to be used for a low-profile mobile terminal device in terms of storage space. A wide-angle camera has a large depth of field, and focuses on a wide range from the near side to the far side of the camera. A subject and a background both appear sharply in a captured image.

### SUMMARY

A first aspect of the present disclosure relates to a device having a camera function. The device having a camera function according to the first aspect includes an image capturing unit configured to capture an image, a light emitter configured to emit light in a photographing direction, and at least one processor configured to control the image capturing unit and the light emitter. The at least one processor is configured to perform a first image capturing operation and a second image capturing operation based on a shutter operation, in the first image capturing operation the image capturing unit capturing a first image without light emission from the light emitter, in the second image capturing operation the image capturing unit capturing a second image with light emission from the light emitter, and divide an area of the first image into an area of a subject and an area of a background based on a difference in state between corresponding portions of the first image and the second image.

A second aspect of the present disclosure relates to a method of image capture. The method of image capture according to the second aspect includes performing a first image capturing operation and a second image capturing operation based on a shutter operation, in the first image capturing operation a first image being captured without light emission in a direction that the first image is captured, in the second image capturing operation a second image being captured with light emission in the direction that the second image is captured, and dividing an area of the first image into an area of a subject and an area of a background based on a difference in state between corresponding portions of the first image and the second image.

A “subject” may refer to all capturing targets including a background and a main capturing target located in front of the background, or may refer to a capturing target located in front of the background. The “subject” in an embodiment refers to the latter capturing target located in front of the background.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1A is a front view of a mobile phone.

FIG. 1B is a rear view of the mobile phone.

FIG. 1C is a right side view of the mobile phone.

FIG. 2 is a block diagram showing an overall configuration of the mobile phone.

FIG. 3 shows a display with a home screen displayed thereon.

FIG. 4 is a flowchart showing an image capturing procedure in a background blurring mode.

FIG. 5A shows a display with an image capturing screen including a preview image displayed thereon.

FIG. 5B shows a display with a save window superimposed on the image capturing screen.

FIG. 6A shows a first captured image.

FIG. 6B shows a second captured image.

FIG. 6C shows a subject area and a background area set in the first captured image.

FIG. 6D shows the first captured image with blurring processing having been applied to the background area.

FIG. 7 is a flowchart showing an image capturing procedure in the background blurring mode.

FIG. 8A is a flowchart showing an image capturing procedure in the background blurring mode.

FIG. 8B shows a display with a color selection window displayed thereon.

FIG. 9A is a flowchart showing an image capturing procedure in the background blurring mode.

FIG. 9B shows how a message prompting for a touch on the display is displayed and a user touches a predetermined position of an image of a subject.

FIG. 10 is a flowchart showing an image capturing procedure in the background blurring mode.

FIG. 11 is a flowchart showing an image capturing procedure in an image combining mode.

FIG. 12A shows an image of the subject area cut out from the first captured image.

FIG. 12B shows a display with a background selection screen displayed thereon.

FIG. 12C shows a combined image with the cut-out image of the subject area pasted to a selected background image.

FIG. 13 shows a display with a message saying that flash emission is to be performed displayed thereon.

### DETAILED DESCRIPTION

A user may want to obtain a captured image in which a subject appears sharply and a background is blurred in order to sharpen the subject. It may be conceivable to obtain a captured image in which a background is blurred by applying blurring processing using a known technique, such as a Blur filter, a Gaussian filter or a Median filter, to the background.

To apply the blurring processing to the background, it may be necessary to divide a captured image into an area of a subject (hereinafter referred to as a “subject area”) and an area of a background (hereinafter referred to as a “background area”).

In this case, it may be desirable that a device be not required to perform complicated processing, that is, it may be desirable that the subject area and the background area can be divided with simple processing.

It may be desired to provide a device having a camera function capable of dividing the area of a captured image into a subject area and a background area with simple processing.

Hereinafter, embodiments of the present disclosure will be described with reference to the drawings.

<Configuration of Mobile Phone>

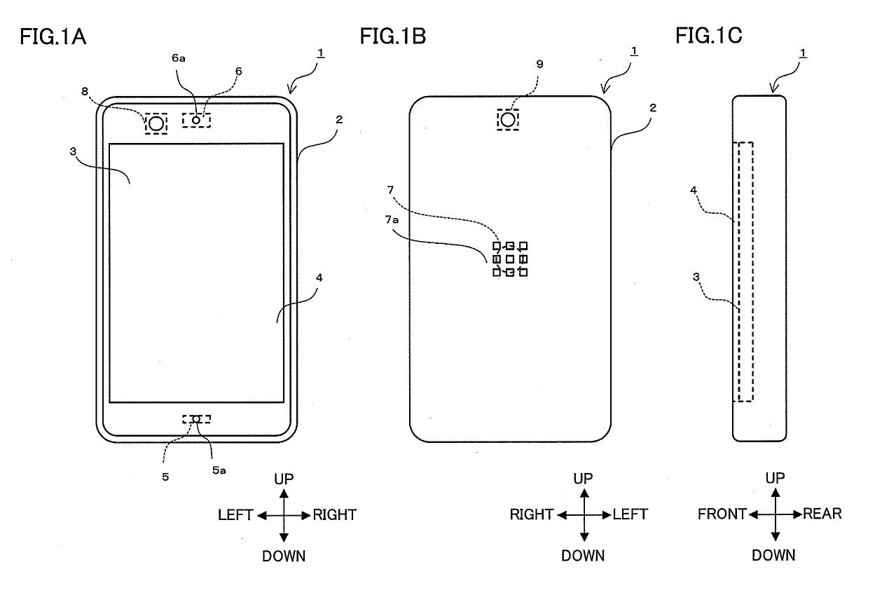

FIGS. 1A, 1B and 1C are a front view, a rear view and a right side view of a mobile phone 1, respectively. Hereinafter, as shown in FIGS. 1A to 1C, the longitudinal direction of a cabinet 2 is defined as the up/down direction, and the shorter direction of cabinet 2 is defined as the left/right direction, for ease of description. The direction perpendicular to these up/down and left/right directions is defined as the front/rear direction.

As shown in FIGS. 1A to 1C, mobile phone 1 may include cabinet 2, a display 3, a touch panel 4, a microphone 5, a conversation speaker 6, an external speaker 7, an in-camera (front-facing camera) 8, and an out-camera (rear-facing camera) 9.

Cabinet 2 may have a substantially rectangular profile, for example, as seen from the front surface. Display 3 may be located on the front surface side of cabinet 2. Various types of images (screens) may be displayed on display 3. Display 3 is a liquid crystal display, for example, and may include a liquid crystal panel and an LED back light which illuminates the liquid crystal panel. Display 3 may be a display of another type, such as an organic electroluminescence display. Touch panel 4 may be located to cover display 3. Touch panel 4 may be located as a transparent sheet. As touch panel 4, various types of touch panels, such as capacitance type, ultrasonic type, pressure-sensitive type, resistive film type, and optical sensing type touch panels, may be used.

Microphone 5 may be located at the lower end within cabinet 2. Conversation speaker 6 may be located at the upper end within cabinet 2. Microphone 5 may receive voice passed through a microphone hole 5a located in the front surface of cabinet 2. Microphone 5 can generate an electrical signal in accordance with received sound. Conversation speaker 6 can output sound. The output sound may be emitted out of cabinet 2 through an output hole 6a located in the front surface of cabinet 2. At the time of a call, received voice from a device of a communication partner (mobile phone etc.) may be output through conversation speaker 6, and user's uttered voice may be input to microphone 5. The sound may include various types of sound, such as voice and an audible alert.

External speaker 7 may be located within cabinet 2. An output hole 7a may be located in the rear surface of cabinet 2 in a region facing external speaker 7. Sound output through external speaker 7 may be emitted out of cabinet 2 through output hole 7a.

At the upper part of cabinet 2, in-camera 8 may be located on the front surface side, and out-camera 9 may be located on the rear-surface side. In-camera 8 and out-camera 9 each include a single-focus wide-angle camera. In-camera 8 can capture an image of a capturing target present on the front surface side of mobile phone 1. In-camera 8 may include an imaging device, such as a CCD (Charge Coupled Device) or a CMOS (Complementary Metal Oxide Semiconductor) sensor, and a single-focus wide-angle lens by which a capturing target is imaged on the imaging device.

Out-camera 9 can capture an image of a capturing target present on the rear surface side of mobile phone 1. Out-camera 9 may include an imaging device, such as a CCD or a CMOS sensor, a single-focus wide-angle lens by which a capturing target is imaged on the imaging device, and a focus lens for focus adjustment.

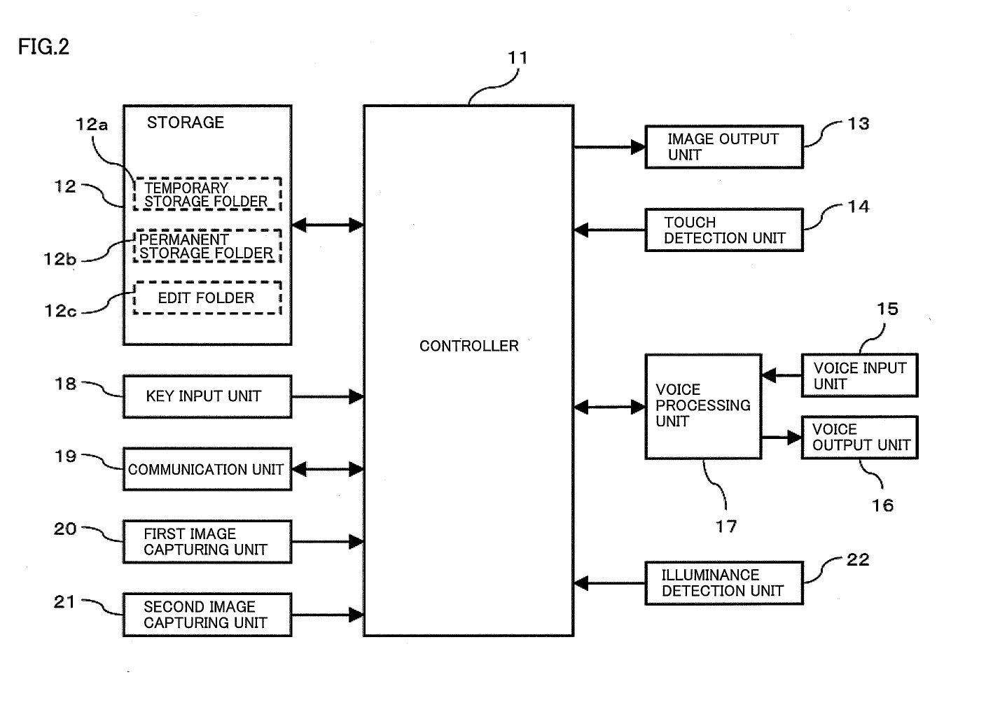

FIG. 2 is a block diagram showing an overall configuration of mobile phone 1.

As shown in FIG. 2, mobile phone 1 may include a controller 11, a storage 12, an image output unit 13, a touch detector 14, a voice input unit 15, a voice output unit 16, a voice processing unit 17, a key input unit 18, a communication unit 19, a first image capturing unit 20, a second image capturing unit 21, and an illuminance detector 22.

Storage 12 may include at least one of a ROM (Read Only Memory), a RAM (Random Access Memory), and an external memory. Storage 12 may have various types of programs stored therein. The programs stored in storage 12 may include various application programs (hereinafter briefly referred to as “applications”), for example, applications for telephone, message, camera, web browser, map, game, schedule management, and the like, in addition to a control program for controlling each unit of mobile phone 1. The programs stored in storage 12 may also include a program for executing an image capturing procedure in various types of image capturing modes, such as a background blurring mode which will be described later. The programs are stored in storage 12 by a manufacturer during manufacture of mobile phone 1, or may be stored in storage 12 through a communication network or storage medium, such as a memory card or a CD-ROM.

Storage 12 may also include a working area for storing data temporarily utilized or generated while a program is executed.

For images captured by in-camera 8 and out-camera 9, storage 12 may have prepared therein a temporary storage folder 12a temporarily storing images (image data) and a permanent storage folder 12b permanently storing images (image data). Storage 12 may also have prepared therein an edit folder 12c temporarily storing images (image data) obtained by a first image capturing operation and a second image capturing operation in the image capturing procedure in the background blurring mode.

Controller 11 may include at least one processor. The processor includes one or more circuits or units configurable to perform one or more data computing procedures or processes. In accordance with various embodiments, the at least one processor may be implemented as a single integrated circuit (IC) or as multiple communicatively coupled IC's and/or discrete circuit. The at least one processor includes CPU (Central Processing Unit), for example. When the at least one processor executes the control program stored in storage 12, controller 11 can control each unit constituting mobile phone 1 (storage 12, image output unit 13, touch detector 14, voice input unit 15, voice output unit 16, voice processing unit 17, key input unit 18, communication unit 19, first image capturing unit 20, second image capturing unit 21, illuminance detector 22, and the like).

Image output unit 13 may include display 3 shown in FIG. 1A. Image output unit 13 can cause display 3 to display an image (screen) based on a control signal and an image signal received from controller 11. Image output unit 13 can turn on, turn off, and adjust intensity of, display 3 in response to control signals received from controller 11. Image output unit 13 can apply a voltage higher than that in a normal operation to an LED back light for a short time period in response to a control signal from controller 11 to cause display 3 to emit a flash. At this time, when the whole surface of the liquid crystal panel is rendered to be white, a white (colorless) flash may be emitted, and when the whole surface of the liquid crystal panel is rendered to have a predetermined chromatic color, such as red, blue or green, a flash of the predetermined chromatic color may be emitted.

Touch detector 14 can include touch panel 4 shown in FIG. 1A, and can detect a touch operation on touch panel 4. More specifically, touch detector 14 can detect a position (hereinafter referred to as a “touch position”) at which a contact object, such as a user's finger, contacts touch panel 4. Touch detector 14 can output a position signal generated based on a detected touch position to controller 11. The touch operation on touch panel 4 is intended for a screen or an object displayed on display 3, and can be rephrased as a touch operation on display 3.

Touch detector 14 may be configured to, when a user's finger has approached display 3, namely, touch panel 4, detect a position where the user's finger has approached as a touch position. For example, when touch panel 4 of touch detector 14 is of a capacitance type, the sensitivity thereof may be adjusted such that a change in capacitance exceeds a detection threshold value when a finger has approached touch panel 4. When the front surface of cabinet 2 including touch panel 4 is covered with a transparent cover made of glass or the like, a finger intended to be brought into contact with touch panel 4 may touch the cover rather than touch panel 4. In this case, touch panel 4 can detect a touch position when the finger has come into contact with or approached the cover.

A user can perform various touch operations on image display 3 by touching touch panel 4 with his/her finger or bringing his/her finger closer thereto. The touch operation may include a tap operation, a flick operation, a sliding operation, and the like, for example. The tap operation includes an operation that a user contacts touch panel 4 with his/her finger, and then lifts the finger from touch panel 4 after a short period of time. The flick operation includes an operation that a user contacts touch panel 4 with his/her finger or brings his/her finger closer thereto, and then flicks or sweeps touch panel 4 with the finger in any direction. The sliding operation includes an operation that a user moves his/her finger in any direction with the finger kept in contact with or in proximate to touch panel 4.

For example, in the case where touch detector 14 detects a touch position, when the touch position is no longer detected within a predetermined first time period after the touch position is detected, controller 11 can determine that the touch operation is a tap operation. In the case where a touch position is moved by a predetermined first distance or more within a predetermined second time period after the touch position is detected, and then the touch position is no longer detected, controller 11 can determine that the touch operation is a flick operation. When a touch position is moved by a predetermined second distance or more after the touch position is detected, controller 11 can determine that the touch operation is a sliding operation.

Voice input unit 15 may include microphone 5. Voice input unit 15 can output an electrical signal from microphone 5 to voice processing unit 17.

Voice output unit 16 may include conversation speaker 6 and external speaker 7. An electrical signal received from voice processing unit 17 may be input to voice output unit 16. Voice output unit 16 can cause sound to be output through conversation speaker 6 or external speaker 7.

Voice processing unit 17 can perform A/D conversion or the like on an electrical signal received from voice input unit 15, and can output a digital audio signal after conversion to controller 11. Voice processing unit 17 can perform decoding and D/A conversion or the like on a digital audio signal received from controller 11, and can output an electrical signal after conversion to voice output unit 16.

Key input unit 18 may include at least one or more hard keys. For example, key input unit 18 may include a power key for turning on mobile phone 1, and the like. Key input unit 18 can output a signal corresponding to a pressed hard key to controller 11.

Communication unit 19 may include a circuit for converting a signal, an antenna that transmits/receives electric waves, and the like, in order to make calls and communications. Communication unit 19 can convert a signal for a call or communication received from controller 11 into a radio signal, and can transmit the converted radio signal to a communication destination, such as a base station or another communication device, through the antenna. Communication unit 19 can convert a radio signal received through the antenna into a signal in the form that can be utilized by controller 11, and can output the converted signal to controller 11.

First image capturing unit 20 may include in-camera 8 shown in FIG. 1A, an image capturing control circuit and the like. First image capturing unit 20 can subject image data of an image captured by in-camera 8 to various types of image processing, and can output the image data after the image processing to controller 11. First image capturing unit 20 may have an automatic exposure function. First image capturing unit 20 can adjust an exposure value (f-number and/or shutter speed) in accordance with the amount of light taken into the wide-angle lens so as to obtain correct exposure. First image capturing unit 20 may also have an automatic white balance function. First image capturing unit 20 can adjust a white balance value in accordance with light taken into the wide-angle lens.

Second image capturing unit 21 may include out-camera 9 shown in FIG. 1B, an image capturing control circuit and the like. Second image capturing unit 21 can subject image data of an image captured by out-camera 9 to various types of image processing, and can output the image data after the image processing to controller 11. Second image capturing unit 21 may have an automatic exposure function and an automatic white balance function, similarly to first image capturing unit 20. Second image capturing unit 21 may also have an auto-focus function. Second image capturing unit 21 can move the focus lens to adjust the focus.

Illuminance detector 22 includes an illuminance sensor and the like, and can detect ambient brightness. The illuminance sensor may output a detection signal in accordance with the ambient brightness, and the detection signal may be input to controller 11. Controller 11 can adjust the intensity of display 3 in accordance with the ambient brightness.

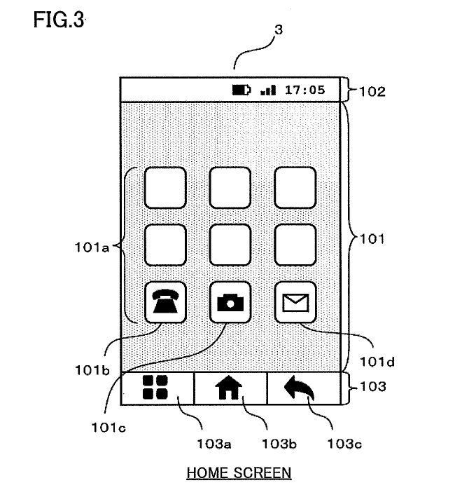

FIG. 3 shows display 3 with home screen 101 displayed thereon.

In mobile phone 1, various screens can be displayed on display 3, and a user may perform various touch operations on each screen. For example, home screen 101 may be displayed on display 3 as an initial screen. As shown in FIG. 3, home screen 101 may include start-up icons 101a for starting up various types of applications, respectively. Start-up icons 101a may include, for example, a telephone icon 101b, a camera icon 101c, an e-mail icon 101d, and the like.

A notification bar 102 and an operation key group 103 may be displayed on display 3 in addition to home screen 101. Notification bar 102 may be displayed above home screen 101. Notification bar 102 may include a current time, a capacity meter indicating the battery capacity, a strength meter indicating the strength of electric waves, and the like. Operation key group 103 may be displayed under home screen 101. Operation key group 103 may be composed of a setting key 103a, a home key 103b and a back key 103c. Setting key 103a includes a key mainly for causing display 3 to display a setting screen for performing various types of setting. Home key 103b includes a key mainly for causing the display of display 3 to shift to home screen 101 from another screen. Back key 103c includes a key mainly for returning executed processing to processing of an immediately preceding step.

When using each application, a user may perform a tap operation on start-up icon 101a corresponding to an application to be used. When the application is started up, an execution screen based on the application may be displayed. Even when the execution screen of the started-up application is displayed or even when the execution screen transitions as the application proceeds, notification bar 102 and operation key group 103 may be continuously displayed on display 3.

When a user performs a tap operation on camera icon 101c on home screen 101, the camera application may be started up. The camera application may have various types of image capturing modes.

### First Embodiment

Since in-camera 8 and out-camera 9 installed in mobile phone 1 may each include a wide-angle camera, they may achieve focus in a wide range from the near side to the far side of the camera when performing image capturing in a normal image capturing mode. Therefore, in an image captured in the normal image capturing mode, a subject on the near side of the camera and the background on the far side can both appear sharply. A user may want to obtain a captured image in which a subject appears sharply and a background is blurred in order to sharpen the subject. In the first embodiment, mobile phone 1 has a background blurring mode as one of the image capturing modes. The background blurring mode includes an image capturing mode by which a subject, such as a person, appears sharply and a background is blurred in a captured image in order to sharpen the subject. For image capturing in the background blurring mode, in-camera 8 (first image capturing unit 20) may be used.

When a user selects the background blurring mode on a screen (not shown) for selecting the image capturing mode displayed on display 3, the image capturing mode may be set at the background blurring mode. The background blurring mode will be described below.

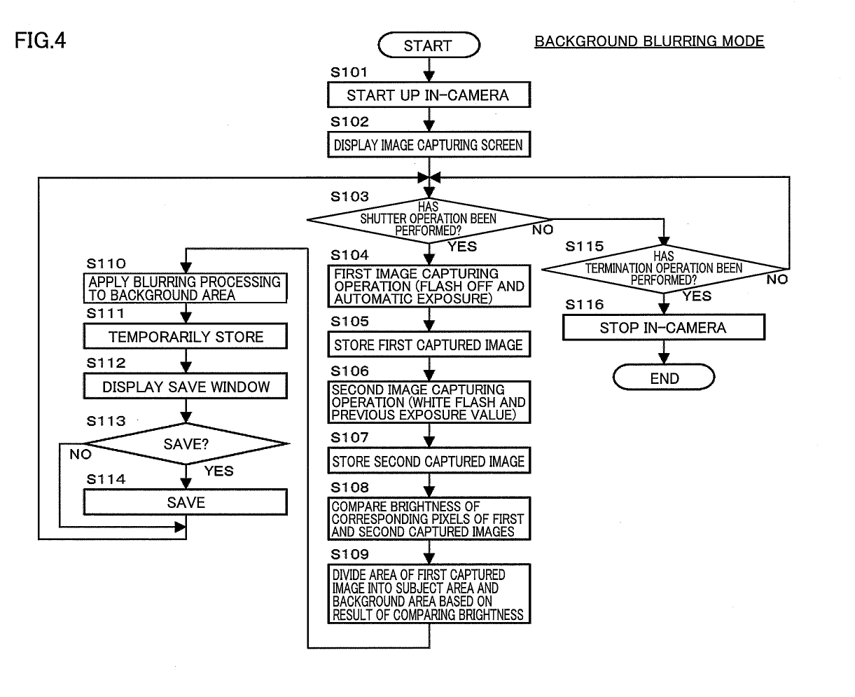

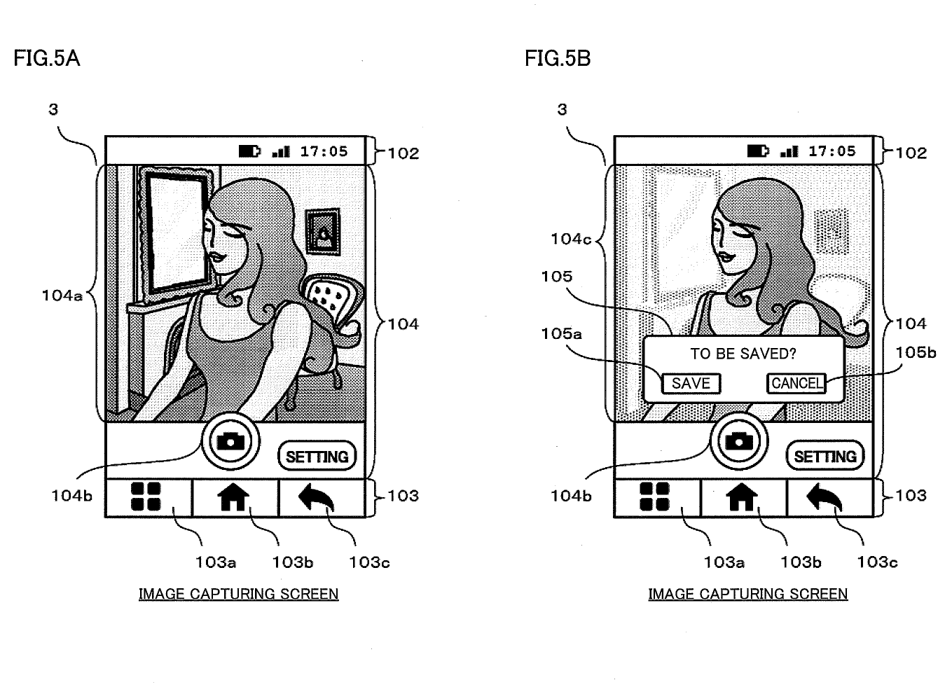

FIG. 4 is an example of a flowchart showing an image capturing procedure in the background blurring mode. FIG. 5A shows display 3 with an image capturing screen 104 which may include a preview image 104a displayed thereon. FIG. 5B shows display 3 with a save window 105 superimposed on image capturing screen 104.

When the camera application is started up with the background blurring mode being set, the image capturing procedure in the background blurring mode may be started.

Controller 11 can start up in-camera 8 (S101), and can control image output unit 13 to cause display 3 to display image capturing screen 104 (S102).

As shown in FIG. 5A, image capturing screen 104 may include preview image 104a and a shutter object 104b. Preview image 104a may be displayed for a user to check in advance what image is to be captured. Preview image 104a may be an image of lower resolution than an image to be captured, and may be displayed in the state of a moving image. Shutter object 104b may be used for a shutter operation.

Controller 11 can determine whether or not the shutter operation has been performed (S103). When a user performs a tap operation on shutter object 104b, it may be determined that the shutter operation has been performed.

When the shutter operation has been performed (YES in S103), controller 11 can perform the first image capturing operation with in-camera 8 (S104). In the first image capturing operation, controller 11 does not cause display 3 to emit a flash. Controller 11 uses the automatic exposure function to determine an exposure value at which correct exposure will be obtained, and performs image capturing at the determined exposure value. Controller 11 can store image data of an image obtained by the first image capturing operation (hereinafter referred to as a “first captured image”) in edit folder 12c (S105).

Controller 11 can perform the second image capturing operation subsequent to the first image capturing operation (S106). The interval between the first image capturing operation and the second image capturing operation may be set at such a short time period that a subject will not move in that interval. In the second image capturing operation, controller 11 causes display 3 to emit a flash. At this time, controller 11 can render the whole surface of display 3 to be white. A white (colorless) flash may thus be emitted from display 3. Controller 11 can perform image capturing at the exposure value used in the first image capturing operation, without using the automatic exposure function. Controller 11 can store image data of an image obtained by the second image capturing operation (hereinafter referred to as a “second captured image”) in edit folder 12c (S107).

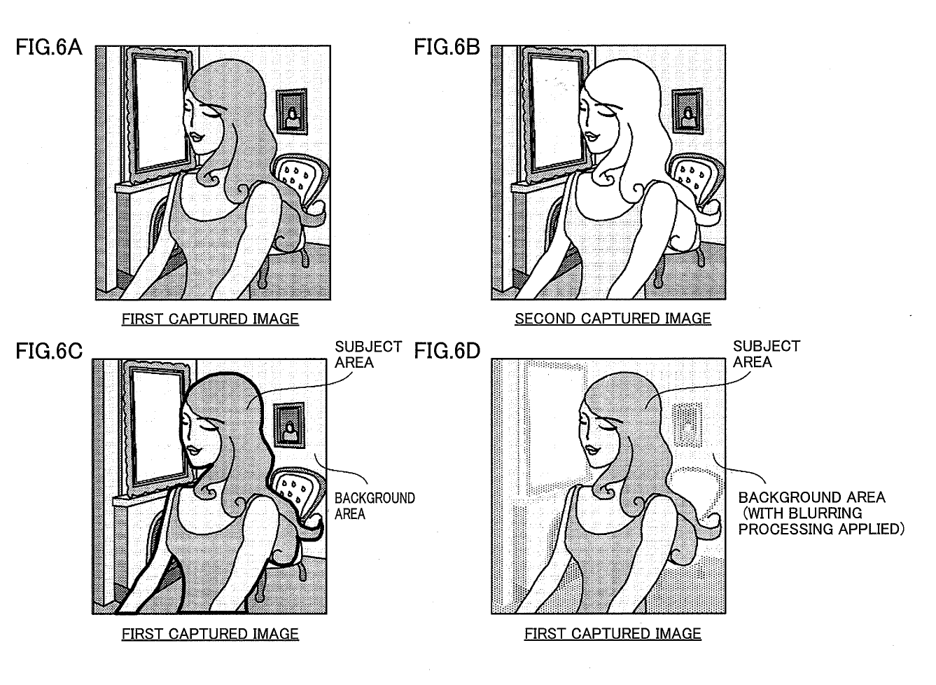

FIG. 6A shows the first captured image, and FIG. 6B shows the second captured image. FIG. 6C shows a subject area and a background area set in the first captured image. FIG. 6D shows the first captured image with blurring processing having been applied to the background area. FIGS. 6A to 6D show an instance where an image of a person has been captured in a room.

Referring to FIGS. 6A and 6B, as seen from in-camera 8, the person who is a subject is located on the near side of the camera, and the scene of the room which is a background is located on the far side. In the second image capturing operation, a white flash may be used. Therefore, in the second captured image, the subject (person) located on the near side of the camera to which a flash reaches easily may appear more brightly than in the first captured image, and the background (scene of the room) located on the far side to which a flash is difficult to reach may appear at the same degree of brightness as in the first captured image. Although the amount of light taken into in-camera 8 may be larger in the second image capturing operation since a flash may be emitted, the exposure value used in the first image capturing operation may be used without performing exposure adjustment by the automatic exposure function in accordance with the increased amount of light. Therefore, in the second image capturing operation, the subject may appear more brightly.

Controller 11 can compare the brightness of corresponding pixels of the first and second captured images (S108), and based on the comparison result, can divide the area of the first captured image into the subject area and the background area (S109). As shown in FIG. 6C, in the first captured image, controller 11 can set an area composed of pixels differing in brightness as the subject area, and can set an area composed of pixels having the same brightness as the background area. For example, when the difference in brightness between a pixel of interest in the first captured image and a pixel in the second captured image located at the same position as the pixel of interest in the first captured image is larger than a predetermined threshold value, controller 11 can regard the pixel of interest in the first captured image is a pixel of different brightness.

Controller 11 can apply blurring processing to the background area (S110). As a technique for the blurring processing, a known technique, such as, for example, a Blur filter, a Gaussian filter or a Median filter, can be used. As shown in FIG. 6D, the first captured image may be edited to an image in which the subject appears sharply and the background is blurred.

Controller 11 can temporarily store image data of the edited first captured image in temporary storage folder 12a (S111), and can cause save window 105 for a user to determine whether or not to save the image data to be displayed in a superimposed manner on image capturing screen 104 (S112). As shown in FIG. 5B, save window 105 may include a save object 105a and a cancel object 105b. Image capturing screen 104 may include a saving target image 104c which is the first captured image as edited, instead of preview image 104a.

Controller 11 can determine whether or not to save saving target image 104c (S113). A user can check saving target image 104c, and can operate save object 105a when saving target image 104c is to be saved. When saving target image 104c is not to be saved, the user can operate cancel object 105b. When a touch operation (e.g., a tap operation) on save object 105a is performed, controller 11 can determine that saving target image 104c is to be saved (YES in S113), and can save image data of saving target image 104c in permanent storage folder 12b (S114). Controller 11 can close save window 105, and can return the process to step S103 to wait for another shutter operation. When a touch operation (e.g., a tap operation) on cancel object 105b is performed, controller 11 can determine that saving target image 104c is not to be saved (NO in S113), can close save window 105 without saving the image data of saving target image 104c in permanent storage folder 12b, and can return the process to step S103.

An operation of terminating the camera application, for example, a tap operation on back key 103c, has been performed before a shutter operation is performed (YES in S115), controller 11 can stop in-camera 8 (S116) to terminate the image capturing procedure in the background blurring mode.

According to the first embodiment as described above, mobile phone 1 may have the background blurring mode of dividing the area of a captured image into the subject area and the background area and applying the blurring processing to the background area. By capturing an image in the background blurring mode, a user can obtain a captured image (picture) in which a subject appears sharply.

According to the first embodiment, the first image capturing operation without flash emission and the second image capturing operation with flash emission may be performed successively, and corresponding pixels may be compared in brightness between two captured images, and based on the comparison result, the area of a captured image may be divided into the subject area and the background area. The area of a captured image can thus be divided into the subject area and the background area with simple processing of determining the brightness of corresponding pixels of two captured images, without having to perform relatively complicated processing such as image recognition.

According to the first embodiment, exposure adjustment by the automatic exposure function is not performed in the second image capturing operation in which flash emission is performed. Since a subject may thus appear more brightly, the area of a captured image is more easily divided into the subject area and the background area.

According to the first embodiment, since in-camera 8 located on the same side as display 3 may be used for the background blurring mode, display 3 can be used both for image output unit 13 and a flash light emitter.

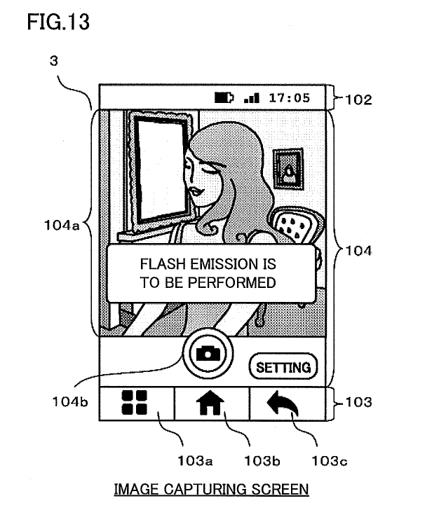

A user may be informed that flash emission is to be performed immediately before the second image capturing operation with flash emission is performed so as not to frighten the user by sudden flash emission. For example, at least one of notices, such as a message displayed on display 3 saying that flash emission is to be performed or an announcement output by voice informing that flash emission is to be performed, may be given. FIG. 13 shows an example where a message saying that flash emission is to be performed is displayed on display 3.

With a configuration in which the first image capturing operation is performed while informing that flash emission is to be performed, it is possible to avoid a considerable delay in image capturing for giving a notice.

<Variation 1>

In the first embodiment described above, in the background blurring mode, white light may be used as a flash, and the division into the subject area and the background area may be made based on the difference in brightness between corresponding pixels of two captured images. In Variation 1, in the background blurring mode, light of a chromatic color, such as red, blue or green, may be used for a flash, and the division into the subject area and the background area may be made based on the difference in color between corresponding pixels of two captured images.

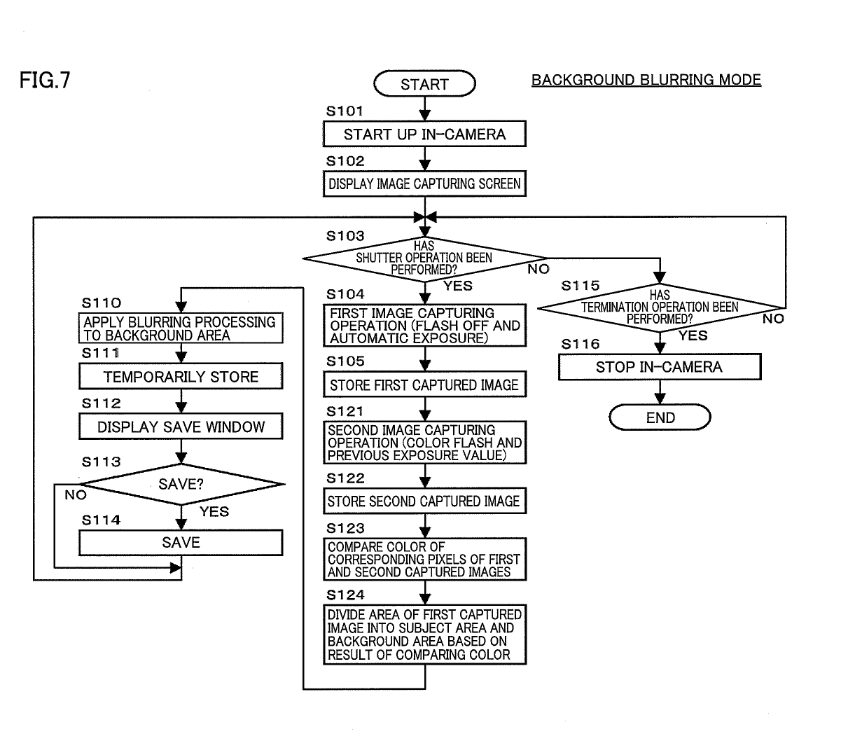

FIG. 7 is an example of a flowchart showing an image capturing procedure in the background blurring mode according to Variation 1. In the image capturing procedure in FIG. 7, steps S106 to step S109 in the image capturing procedure shown in FIG. 4 are replaced by steps S121 to S124. Operations different from those of the image capturing procedure shown in FIG. 4 will be mainly described below.

Upon storage of the first captured image (S105), controller 11 can perform the second image capturing operation (S121). In the second image capturing operation, controller 11 may cause display 3 to emit a flash. At this time, controller 11 can render the whole surface of display 3 to have a predetermined chromatic color. A flash of the predetermined chromatic color may thus be emitted from display 3. The color of a flash can be set at a predetermined chromatic color, such as red, blue or green. Controller 11 can capture an image at the exposure value used in the first image capturing operation without using the automatic exposure function. Controller 11 can store image data of a second captured image in edit folder 12c (S122).

A flash of a chromatic color may be used in the second image capturing operation. In the second captured image, a subject located on the near side of the camera to which a flash easily reaches may be tinged with the color of the flash. The background located on the far side of the camera to which a flash does not reach easily does not assume the color of the flash or change from the first captured image.

Controller 11 can compare the color of corresponding pixels of the first and second captured images (S123), and can divide the area of the first captured image into the subject area and the background area based on the comparison result (S124). In the first captured image, controller 11 can set an area composed of pixels of different colors as the subject area, and can set an area composed of pixels of the same color as the background area. For example, when the difference in chromaticity (X and Y values) between a pixel of interest in the first captured image and a pixel in the second captured image located at the same position as the pixel of interest in the first captured image is larger than a predetermined threshold value, controller 11 can regard the pixel of interest in the first captured image is a pixel of a different color.

Controller 11 can apply blurring processing to the background area (S110). The first captured image may be edited to an image in which the subject appears sharply and the background is blurred.

In the case where white light is used for a flash as in the first embodiment described above, when the brightness around mobile phone 1 is very high, such as under the sunlight in the daytime, a difference in brightness is less likely to be made between subjects in the first captured image and the second captured image even with a flash emitted to the subjects. It may be difficult to make the division into the subject area and the background area. In the case where light of a chromatic color is used for a flash as in Variation 1, a difference in color can be imparted to the subjects in the two captured images by emitting a flash even when the brightness around mobile phone 1 is very high. Therefore, it is easier to make the division into the subject area and the background area.

<Variation 2>

In a Variation 2, the color of a flash may be set for each captured image by a user's selection operation. In more detail, a user may select the main color of a subject, and a complementary color of the selected color may be set as the color of a flash.

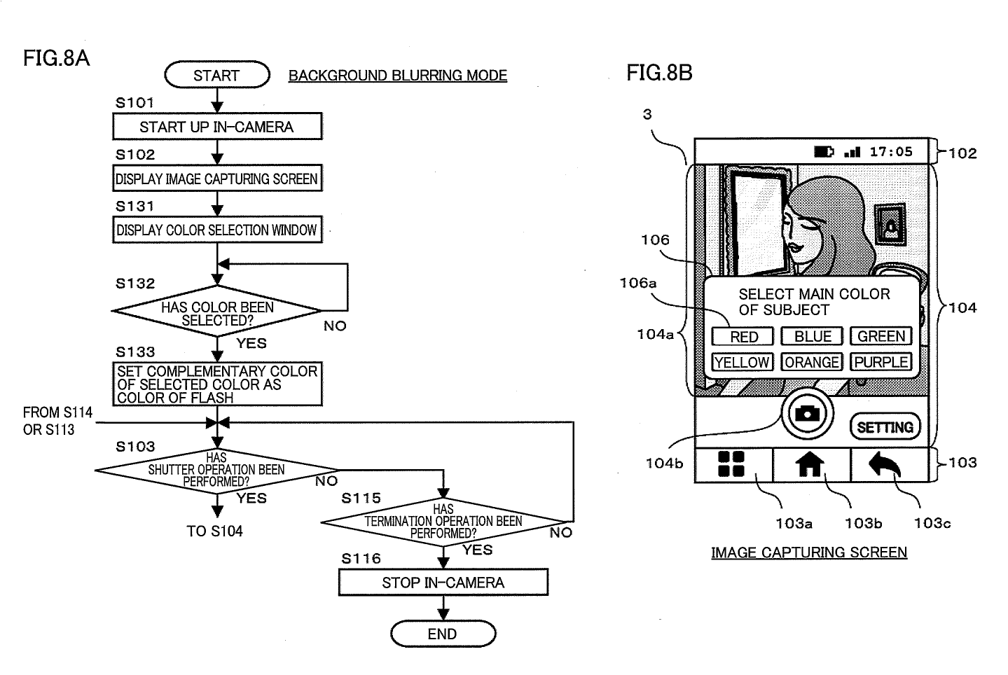

FIG. 8A is an example of a flowchart showing an image capturing procedure in the background blurring mode according to Variation 2. FIG. 8B shows display 3 with a color selection window 106 displayed thereon. In the image capturing procedure shown in FIG. 8A, steps S131 to S133 are inserted between steps 102 and S103 in the image capturing procedure shown in FIG. 7. In FIG. 8A, illustration of some of operations identical to those of the image capturing procedure shown in FIG. 7 is omitted for the sake of convenience. Operations different from those of the image capturing procedure shown in FIG. 7 will be mainly described below.

When image capturing screen 104 is displayed on display 3 (S102), controller 11 can cause color selection window 106 to be displayed in a superimposed manner on image capturing screen 104 (S131). As shown in FIG. 8B, selection objects 106a corresponding to respective colors of selection candidates may be located in color selection window 106. A message on color selection window 106 may prompt a user to select the main color of a subject. When a color is selected by a touch operation (e.g., a tap operation) on any of selection windows 106a (YES in S132), controller 11 can set the complementary color of the selected color as the color of a flash (S133).

When the user makes a shutter operation, the first image capturing operation and the second image capturing operation may be performed (S103 to S122). In the second image capturing operation, a flash of the color set in step S133 may be emitted from display 3.

According to Variation 2, since a flash of the complementary color of the main color of a subject can be emitted to the subject, a difference in color is likely to be made between the subjects in the first captured image and the second captured image. It is thus easier to make the division into the subject area and the background area.

<Variation 3>

In Variation 2 described above, a user may select any color from among the plurality of candidates on color selection window 106. In Variation 3, the color of a portion of an image of a subject touched by a user may be obtained, and the complementary color of the obtained color may be set as the color of a flash.

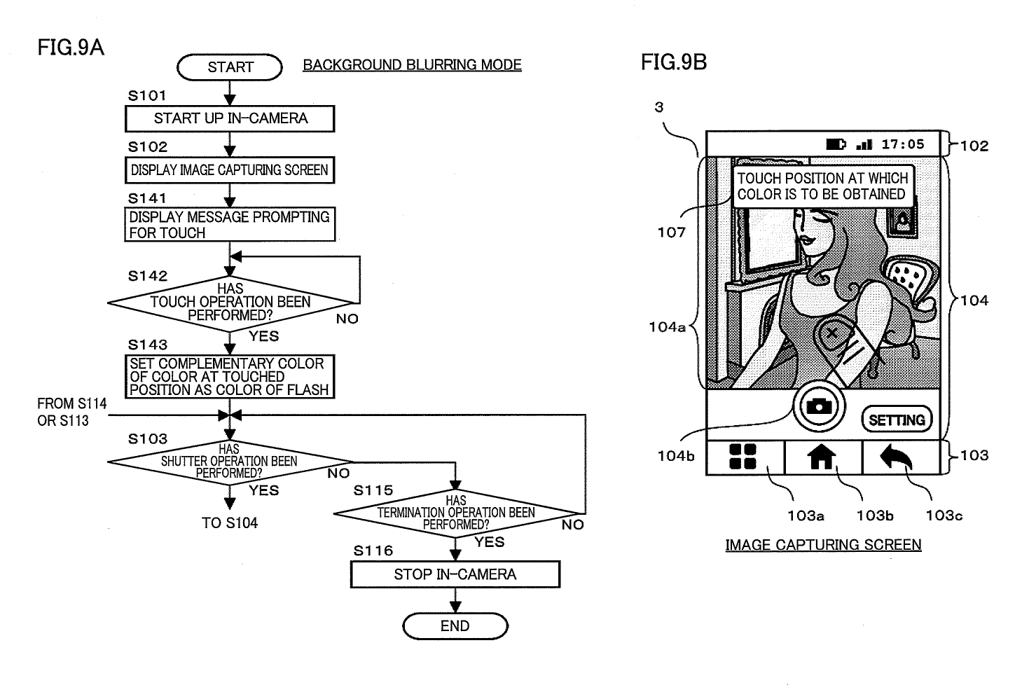

FIG. 9A is an example of a flowchart showing an image capturing procedure in the background blurring mode according to Variation 3. FIG. 9B shows how a message 107 prompting for a touch on display 3 is displayed and a user touches a predetermined position of an image of a subject. In the image capturing procedure shown in FIG. 9A, steps S141 to S143 are inserted between steps S102 and S103 in the image capturing procedure shown in FIG. 7. In FIG. 9A, illustration of some of operations identical to those of the image capturing procedure shown in FIG. 7 is omitted for the sake of convenience. Operations different from those of the image capturing procedure shown in FIG. 7 will be mainly described below.

When image capturing screen 104 is displayed on display 3 (S102), controller 11 can cause message 107 that prompts a user to touch a position at which the color is to be obtained to be displayed in a superimposed manner on image capturing screen 104 (S141). As shown in FIG. 9B, the user can perform a touch operation (e.g., a tap operation) on a portion that occupies the main color of a subject. When a touch operation is performed (YES in S142), controller 11 can obtain the color at the touched position from preview image 104a, and can set the complementary color of the obtained color as the color of a flash (S143).

When the user performs a shutter operation, the first image capturing operation and the second image capturing operation may be performed (S103 to S122). In the second image capturing operation, a flash of the color set in step S143 may be emitted from display 3.

According to Variation 3, since a flash of the complementary color of the main color of a subject can be emitted to the subject, a difference in color is likely to be made between the subjects in the first and second captured images. It is therefore easier to make the division into the subject area and the background area.

According to Variation 3, a user can select the actual color that a subject has, and can set the complementary color of the actual color as the color of a flash.

<Variation 4>

In Variation 4, white or a chromatic color may be selected automatically as the color of a flash in accordance with the brightness around mobile phone 1. From the foregoing reasons, it is desirable to use a flash of a chromatic color when the brightness around mobile phone 1 is very high. When the LED back light of display 3 is caused to emit light at the same intensity, a white flash may cause the whole white light from the LED back light to pass through the liquid crystal panel, while a flash of a chromatic color may cause light of some colors (wavelengths) in white light from the LED back light to be removed by the liquid crystal panel and may cause the remaining light to pass through the liquid crystal panel as light of a chromatic color. The intensity of a white flash may be higher than that of a flash of a chromatic color. Since a white flash is likely to reach farther, it is desirable to use a white flash when the ambient intensity is not very high.

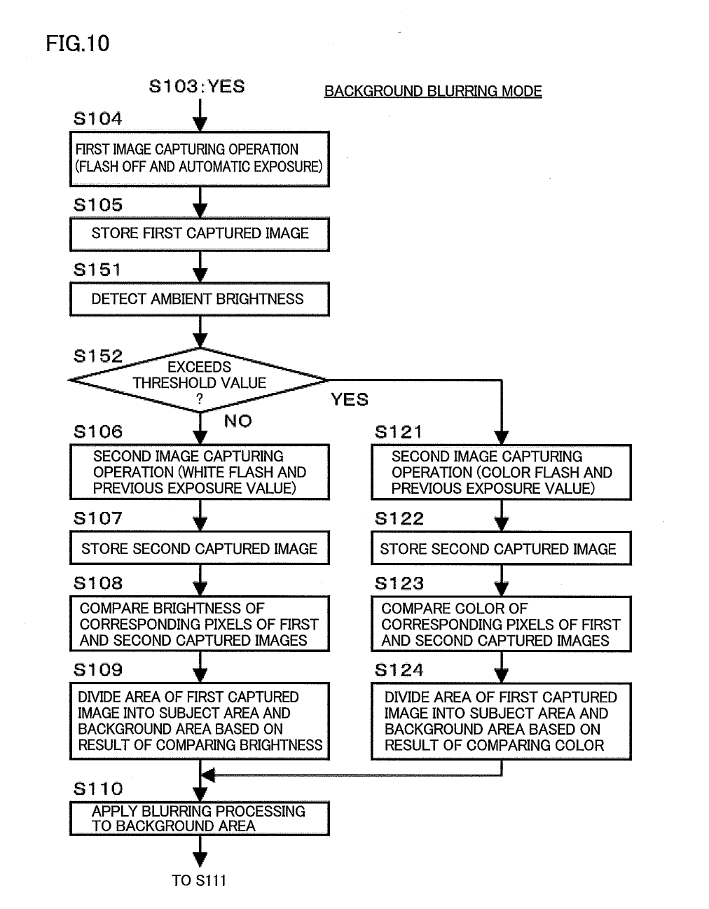

FIG. 10 is an example of a flowchart showing an image capturing procedure in the background blurring mode according to Variation 4. In the image capturing procedure shown in FIG. 10, steps S151 and S152 are inserted between steps S105 and S106 in the image capturing procedure shown in FIG. 4, and steps S121 to S124 are added. In FIG. 10, illustration of some of operations identical to those of the image capturing procedure shown in FIG. 4 is omitted for the sake of convenience. Operations different from those of the image capturing procedure shown in FIG. 4 will be mainly described below.

Upon storage of the first captured image (S105), controller 11 can cause illuminance detector 22 to detect the ambient brightness around mobile phone 1 (S151). Controller 11 can determine whether or not the detected brightness exceeds a predetermined threshold value (S152). The predetermined threshold value may be set in advance by an experiment or the like.

When the detected brightness does not exceed the predetermined threshold value (NO in S152), controller 11 can perform the second image capturing operation with a white flash emitted, and can divide the area of the first captured image into the subject area and the background area based on the difference in brightness between corresponding pixels of the first and second captured images (S106 to S109). When the detected brightness exceeds the predetermined threshold value (YES in S152), controller 11 can perform the second image capturing operation with a flash of a chromatic color emitted, and can divide the area of the first captured image into the subject area and the background area based on the difference in color between corresponding pixels of the first and second captured images (S121 to S124).

According to Variation 4, the color of a flash may be set at a color between white and a chromatic color which is more likely to make a difference in state (brightness or color) between subjects of the first and second captured images in accordance with the ambient brightness around mobile phone 1. It is therefore easier to make the division into the subject area and the background area.

### Second Embodiment

A user may sometimes want to paste a subject in a certain captured image to another background to create a combined image. For example, a case of pasting a subject included in an image captured outdoors to a plain background to create an ID photo may be conceivable. In the second embodiment, mobile phone 1 may have an image combining mode as one of the image capturing modes. In-camera 8 (first image capturing unit 20) may be used for image capturing in the image combining mode.

When a user selects the image combining mode on a screen (not shown) for selecting the image capturing mode displayed on display 3, the image capturing mode may be set at the image combining mode. The image combining mode will be described below.

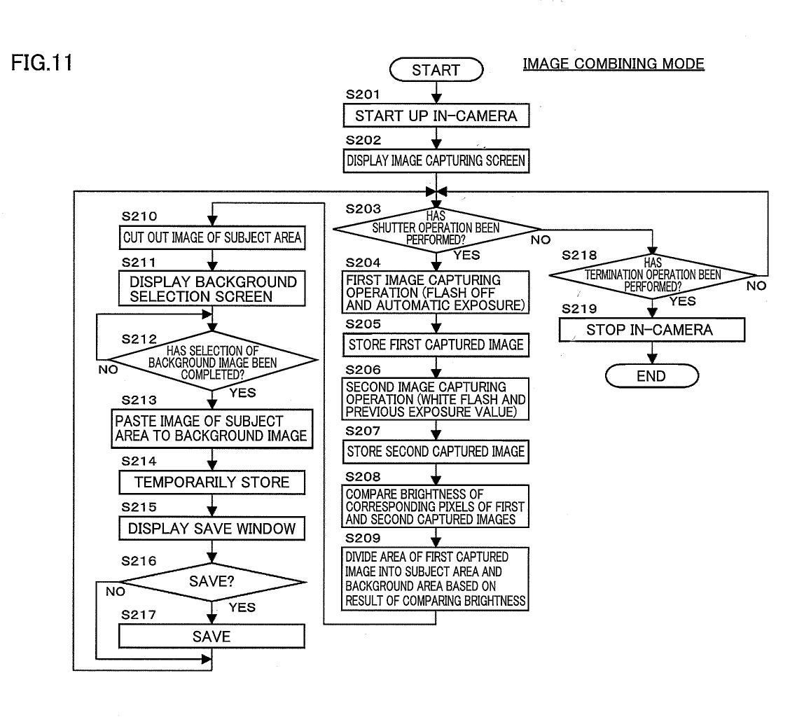

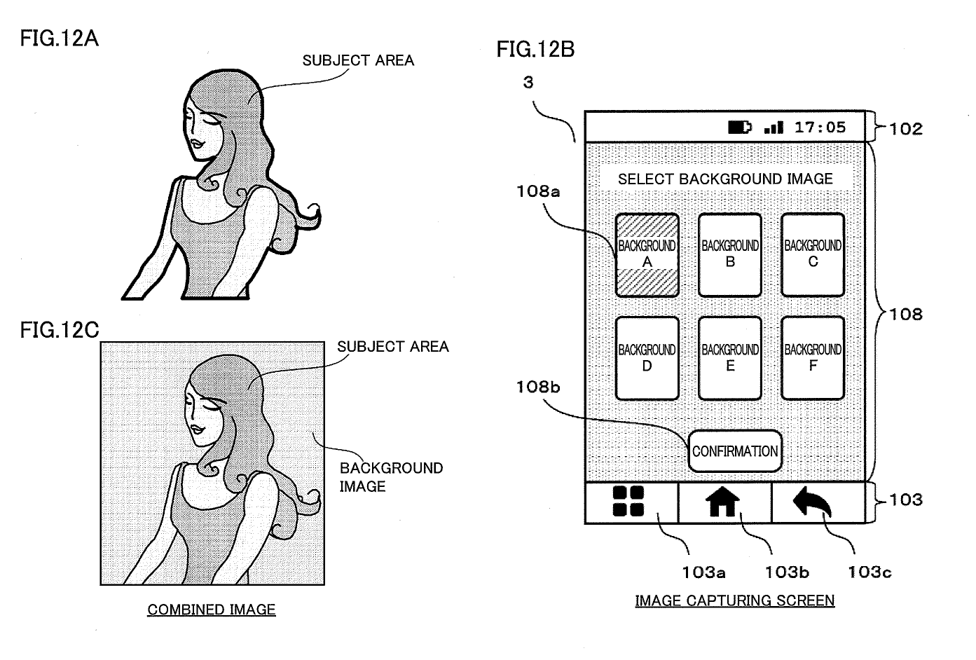

FIG. 11 is an example of a flowchart showing an image capturing procedure in the image combining mode. FIG. 12A shows an image of the subject area cut out from the first captured image. FIG. 12B shows display 3 with a background selection screen 108 displayed thereon. FIG. 12C shows a combined image with the cut-out image of the subject area pasted to a selected background image.

To cut out a subject from a captured image, it may be necessary to divide the area of the captured image into the subject area and the background area. The image capturing procedure in the image combining mode may thus include an operation of dividing the area of a captured image into the subject area and the background area, similarly to the first embodiment described above.

Referring to FIG. 11, when the image capturing procedure in the image combining mode is started, controller 11 can start up in-camera 8 (S201), and can cause display 3 to display image capturing screen 104 (S202), similarly to the first embodiment described above. When the shutter operation has been performed (YES in S203), controller 11 can perform the first image capturing operation and second image capturing operation successively, and can divide the area of the first captured image into the subject area and the background area based on the difference in brightness between corresponding pixels of the first and second captured images (S204 to S209). Controller 11 can cut out an image of the subject area from the first captured image as shown in FIG. 12A (S210).

Controller 11 can cause display 3 to display background selection screen 108 for a user to select a background image (S211). As shown in FIG. 12B, background selection screen 108 may include background image thumbnails 108a which are selection candidates and a confirmation object 108b.

A user can select desired background image thumbnail 108a by a touch operation (e.g., a tap operation), and can perform a touch operation (e.g., a tap operation) on confirmation object 108b. Controller 11 can determine that selection of a background image has been completed (YES in S212), and can paste the cut-out image of the subject area to the selected background image (S213). As shown in FIG. 12C, a combined image may be generated. Controller 11 can temporarily store image data of the generated combined image in temporary storage folder 12a (S214).

Controller 11 can cause save window 105 to be displayed in a superimposed manner on image capturing screen 104, similarly to the first embodiment described above (S215, see FIG. 5B). When a touch operation (e.g., a tap operation) has been performed on save object 105a, controller 11 can determine that the image data of the combined image is to be saved (YES in S216), and can save the image data in permanent storage folder 12b (S217).

When an operation of terminating the camera application has been performed before the shutter operation is performed (YES in S218), controller 11 can stop in-camera 8 (S219) to terminate the image capturing procedure in the image combining mode.

As described above, according to the second embodiment, mobile phone 1 can have the image combining mode of dividing the area of a captured image into the subject area and the background area, and cutting out an image of the subject area and pasting the cut-out image to a predetermined background image to create a combined image. By capturing an image in the image combining mode, a user can obtain a combined image (composite picture) with a subject superimposed on a desired background.

According to the second embodiment, the area of a captured image can be divided into the subject area and the background area with simple processing of determining the brightness of corresponding pixels of two captured images, similarly to the first embodiment described above.

The configuration of the second embodiment can be combined with the configurations of Variations 1 to 4 as appropriate. In this case, step S110 of the image capturing procedure according to Variations 1 to 4 may be replaced by steps S210 to S213 in the image capturing procedure according to the second embodiment.

<Other Variations>

Although the embodiments of the present disclosure have been described above, the present disclosure is not restricted at all by the above-described embodiments and the like, and various modifications can be made to the embodiments of the present disclosure besides the above description.

For example, in the first embodiment and the like, the second image capturing operation may be performed subsequent to the first image capturing operation. However, the first image capturing operation may be performed subsequent to the second image capturing operation. In this case, the exposure value used for the second image capturing operation may be set in accordance with the amount of light taken into a wide-angle lens before the image capturing, for example.

When the first image capturing operation is performed subsequent to the second image capturing operation, it is possible to simultaneously produce the shutter sound based on a shutter operation and light emission for the second image capturing operation, which can prevent a considerable time lag between them. This enables an operation causing relatively less discomfort to a user.

In the first embodiment and the like, display 3 (image output unit 13) may be used as the flash light emitter as well. A dedicated light emitter which emits a flash may be located in cabinet 2.

In the first embodiment and the like, in-camera 8 (first image capturing unit 20) may be used for the background blurring mode and the image combining mode. Out-camera 9 (second image capturing unit 21) may be used for the background blurring mode and the image combining mode. In this case, a dedicated light emitter which emits a flash in the direction that out-camera 9 captures an image may be located in cabinet 2. Alternatively, when a sub-display is located on the rear-surface side of cabinet 2, the sub-display may be used as the flash light emitter as well.

In the first embodiment and the like, in-camera 8 and out-camera 9 may be implemented by single-focus wide-angle cameras. In-camera 8 and out-camera 9 do not necessarily need to be single-focus wide-angle cameras, but any other type of camera may be adopted.

In the first embodiment and the like, mobile phone 1 may include two cameras, in-camera 8 and out-camera 9. Mobile phone 1 does not need to include the two cameras, but should only include at least one camera.

In Variation 2, when a user selects the main color of a subject on color selection window 106, the complementary color of the selected color may be set as the color of a flash. Color selection window 106 may be configured for selection of the color of a flash, and the selected color may be set as the color of a flash. In this case, a user may select the complementary color of the main color of a subject on color selection window 106.

In the first embodiment and the like, the automatic exposure function is stopped in the second image capturing operation, but a configuration may be adopted in which the automatic exposure function works in the second image capturing operation.

In the above-described embodiments, the present disclosure is applied to a smartphone type mobile phone. The present disclosure is not limited thereto, but may be applied to other types of mobile phones, such as a bar phone, a flip phone, a slide phone, and the like.

The present disclosure is not limited to mobile phones, but is applicable to various types of camera-equipped mobile terminal devices, such as a PDA and a tablet PC. The present disclosure is also applicable to a digital camera. That is, the present disclosure is applicable to various types of devices having a camera function.

In addition, various changes can be made as appropriate to embodiments of the present disclosure within the scope of a technical idea defined in the claims.

A first aspect of the present disclosure relates to a device having a camera function. The device having a camera function according to the first aspect includes an image capturing unit configured to capture an image, a light emitter configured to emit light in a direction that the image capturing unit captures an image, and at least one processor configured to control the image capturing unit and the light emitter. The at least one processor is configured to perform a first image capturing operation and a second image capturing operation based on a shutter operation, in the first image capturing operation the image capturing unit capturing an image without light emission from the light emitter, in the second image capturing operation the image capturing unit capturing an image with light emission from the light emitter. The at least one processor is configured to divide an area of a first image captured by the first image capturing operation into an area of a subject and an area of a background based on a difference in state between corresponding portions of the first image and a second image captured by the second image capturing operation.

In the device having a camera function according to the first aspect, the at least one processor may be configured to cause the light emitter to emit white light in the second image capturing operation, and divide the area of the first image into the area of the subject and the area of the background based on a difference in brightness between the corresponding portions of the first and second images.

In the device having a camera function according to the first aspect, the at least one processor may be configured to cause the light emitter to emit light of a chromatic color in the second image capturing operation, and divide the area of the first image into the area of the subject and the area of the background based on a difference in color between the corresponding portions of the first and second images.

When the device is configured as described above, the at least one processor may be configured to receive a setting operation for setting the color of the light to be emitted from the light emitter.

When the at least one processor is configured to receive a setting operation as described above, the setting operation may include an operation of causing a user to select a color included in the subject. In this case, the at least one processor may be configured to set a complementary color of the selected color as the color of the light to be emitted from the light emitter.

When the at least one processor is configured to receive a setting operation as described above, the device having a camera function may further include a display unit, and a position detector configured to detect an indicated position on the display unit indicated by a user. In this case, the at least one processor may be configured to cause the display unit to display an image captured by the image capturing unit before the second image capturing operation is performed, and when the indicated position is detected by the position detector with the image being displayed, set a complementary color of the color of the image at the indicated position having been detected as the color of the light to be emitted from the light emitter.

The device having a camera function according to the first aspect may further include a brightness detector configured to detect brightness around the device having a camera function. In this case, the at least one processor may be configured to, when the brightness detected by the brightness detector does not exceed predetermined brightness, cause the light emitter to emit white light in the second image capturing operation and divide the area of the first image into the area of the subject and the area of the background based on a difference in brightness between the corresponding portions of the first and second images, and when the brightness detected by the brightness detector exceeds the predetermined brightness, cause the light emitter to emit light of a chromatic color in the second image capturing operation and divide the area of the first image into the area of the subject and the area of the background based on a difference in color between the corresponding portions of the first and second images.

In the device having a camera function according to the first aspect, the at least one processor may be configured to execute an operation of blurring an image in the area of the background.

In the device having a camera function according to the first aspect, the at least one processor may be configured to cut out an image of the area of the subject from the first image and pastes the cut-out image to a predetermined image to serve as a background.

A second aspect of the present disclosure relates to an image capturing control method. The image capturing control method according to the second aspect includes performing a first image capturing operation and a second image capturing operation based on a shutter operation, in the first image capturing operation an image being captured without light emission in a direction that the image is captured, in the second image capturing operation an image being captured with light emission in the direction that the image is captured, and dividing an area of a first image captured by the first image capturing operation into an area of a subject and an area of a background based on a difference in state between corresponding portions of the first image and a second image captured by the second image capturing operation.

Although the present disclosure has been described and illustrated in detail, it is clearly understood that the same is by way of illustration and example only and is not to be taken by way of limitation, the scope of the present disclosure being interpreted by the terms of the appended claims.

1. A device having a camera function comprising:
an image capturing unit configured to capture an image;
a light emitter configured to emit light in a photographing direction of the image capturing unit; and
at least one processor configured to control the image capturing unit and the light emitter,
the at least one processor being configured to
perform a first image capturing operation and a second image capturing operation based on a shutter operation, in the first image capturing operation the image capturing unit capturing a first image without light emission from the light emitter, in the second image capturing operation the image capturing unit capturing a second image with light emission from the light emitter, and
divide an area of the first image into an area of a subject and an area of a background based on a difference in state between corresponding portions of the first image and the second image.

2. The device having a camera function according to claim 1, wherein the at least one processor is configured to
cause the light emitter to emit white light in the second image capturing operation, and
divide the area of the first image into the area of the subject and the area of the background based on a difference in brightness between the corresponding portions of the first and second images.

3. The device having a camera function according to claim 1, wherein the at least one processor is configured to
cause the light emitter to emit light of a chromatic color in the second image capturing operation, and
divide the area of the first image into the area of the subject and the area of the background based on a difference in color between the corresponding portions of the first and second images.

4. The device having a camera function according to claim 3, wherein the at least one processor is configured to receive a user instruction for setting a color of the light to be emitted from the light emitter.

5. The device having a camera function according to claim 4, wherein
the user instruction includes a selection of a color included in the subject, and
the at least one processor is configured to set a complementary color of the selected color as the color of the light to be emitted from the light emitter.

6. The device having a camera function according to claim 4, further comprising:
a display; and
a position detector configured to detect an indicated position on the display indicated by a user, wherein
the at least one processor is configured to
cause the display to display an image captured by the image capturing unit before the second image capturing operation is performed, and
when the indicated position is detected by the position detector with the image being displayed, set a complementary color of the color of the image at the indicated position having been detected as the color of the light to be emitted from the light emitter.

7. The device having a camera function according to claim 1, further comprising a brightness detector configured to detect brightness around the device, wherein
the at least one processor is configured to
when the brightness detected by the brightness detector does not exceed predetermined brightness, cause the light emitter to emit white light in the second image capturing operation and divide the area of the first image into the area of the subject and the area of the background based on a difference in brightness between the corresponding portions of the first and second images, and
when the brightness detected by the brightness detector exceeds the predetermined brightness, cause the light emitter to emit light of a chromatic color in the second image capturing operation and divide the area of the first image into the area of the subject and the area of the background based on a difference in color between the corresponding portions of the first and second images.

8. The device having a camera function according to claim 1, wherein the at least one processor is configured to execute an operation of blurring in the area of the background.

9. The device having a camera function according to claim 1, wherein the at least one processor is configured to cut out an image of the area of the subject from the first image and paste the cut-out image to a predetermined image to serve as a background.

10. A method of image capture comprising:
performing a first image capturing operation and a second image capturing operation based on a shutter operation, in the first image capturing operation a first image being captured without light emission in a direction that the first image is captured, in the second image capturing operation a second image being captured with light emission in the direction that the second image is captured; and
dividing an area of the first image into an area of a subject and an area of a background based on a difference in state between corresponding portions of the first image and the second image.
